(19) United States
(12) Patent Application Publication
(10) Pub. No.: US 2012/0062134 A1
(43) Pub. Date: Mar. 15, 2012

(54) DRIVING CIRCUIT FOR T8 LED LAMP

(75) Inventors: Hui-Lan Kou, Jhonghe City (TW); Cheng-Feng Tung, Jhonghe City (TW)

(73) Assignee: Xodtec Technology CO., Ltd.

(21) Appl. No.: 12/881,760

(22) Filed: Sep. 14, 2010

(51) Int. Cl. H05B 37/02

(52) U.S. Cl. 315/205

(57) ABSTRACT

A driving circuit for a T8 light-emitting diode (LED) lamp mainly includes two bridge rectifiers. According to the electrical characteristics and the circuit designs of the bridge rectifiers, the T8 LED lamp can be driven to illuminate by the driving circuit while a starter needs not be removed from the T8 lamp holder.

### BACKGROUND OF THE INVENTION

1. Field of the Invention

The present invention relates to a driving circuit for a T8 lamp, and more particularly to a driving circuit for a T8 light-emitting diode (LED) lamp.

2. Description of Prior Art

Nowadays, the conventional T8 light-emitting diode (LED) lamp is widely used. Reference is made to FIG. 3 which is a block diagram of a conventional T8 lamp and a T8 lamp holder 20. A starter 21 is installed between a first lamp contact 22 and a third lamp contact 26 of a T8 lamp holder 20. An AC power source 50 is electrically connected to a fourth lamp contact 28 of the T8 lamp holder 20 through a switch 60.

The AC power source 50 provides electricity in turn to the fourth lamp contact 28, to a conventional T8 lamp 40, the third lamp contact 26, the starter 21, the first lamp contact 22, the conventional T8 lamp 40, and a second lamp contact 24 of the T8 lamp holder 20 when the switch 60 is closed (turned on). Hence, the conventional T8 lamp illuminates.

The conventional T8 lamp 40 has the disadvantages of containing mercury and lacking of energy saving. Hence, a T8 light-emitting diode (LED) lamp is presented to solve the above-mentioned disadvantages.

The starter 21 is needed for operating conventional T8 lamp 40, whereas the starter 21 is not needed for the T8 LED lamp. It is not convenient that the starter 21 needs to be removed when the T8 LED lamp is installed in the T8 lamp holder. If the starter 21 is not removed, the T8 LED lamp can not illuminate.

### SUMMARY OF THE INVENTION

In order to improve the above-mentioned disadvantages, a driving circuit for a T8 light-emitting diode (LED) lamp is disclosed. The driving circuit is provided to drive the T8 LED lamp without removing the starter installed in the T8 lamp holder.

In order to achieve the above-mentioned objectives, a driving circuit for a T8 LED lamp applied to a T8 lamp holder and at least one light-emitting diode. The T8 lamp holder has a first lamp contact, a second lamp contact, a third lamp contact, and a fourth lamp contact. The driving circuit of the T8 LED lamp includes a first diode, a second diode, a third diode, a fourth diode, a fifth diode, a sixth diode, a seventh diode, an eighth diode, an inductor unit, a first capacitor, and a power factor corrector unit.

The first diode has an anode and a cathode, and the cathode of the first diode is electrically connected to the first lamp contact. The second diode has an anode and a cathode, and the anode of the second diode is electrically connected to the first lamp contact. The third diode has an anode and a cathode, and the cathode of the third diode is electrically connected to the second lamp contact and the anode of the third diode is electrically connected to the anode of the first diode. The fourth diode has an anode and a cathode, and the anode of the fourth diode is electrically connected to the second lamp contact and the cathode of the fourth diode is electrically connected to the cathode of the second diode. The fifth diode has an anode and a cathode, and the anode of the fifth diode is electrically connected to the third lamp contact and the cathode of the fifth diode is electrically connected to the cathode of the second diode. The sixth diode has an anode and a cathode, and the cathode of the sixth diode is electrically connected to the third lamp contact and the anode of the sixth diode is electrically connected to the anode of the first diode. The seventh diode has an anode and a cathode, and the anode of the seventh diode is electrically connected to the fourth lamp contact and the cathode of the seventh diode is electrically connected to the cathode of the second diode. The eighth diode has an anode and a cathode, and the cathode of the eighth diode is electrically connected to the fourth lamp contact and the anode of the eighth diode is electrically connected to the anode of the first diode. The inductor unit has a first terminal and a second terminal, and the first terminal is electrically connected to the cathode of the second diode. The first capacitor has a first terminal and a second terminal, and the first terminal of the first capacitor is electrically connected to the second terminal of the inductor unit and the second terminal of the first capacitor is electrically connected to the anode of the first diode. The power factor corrector is electrically connected to the cathode of the second diode.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a block diagram of a driving circuit for a T8 LED lamp according to the present invention;

FIG. 2 is a block diagram of an equivalent circuit of the driving circuit for the T8 LED lamp; and

FIG. 3 is a block diagram of a conventional T8 lamp and a T8 lamp holder.

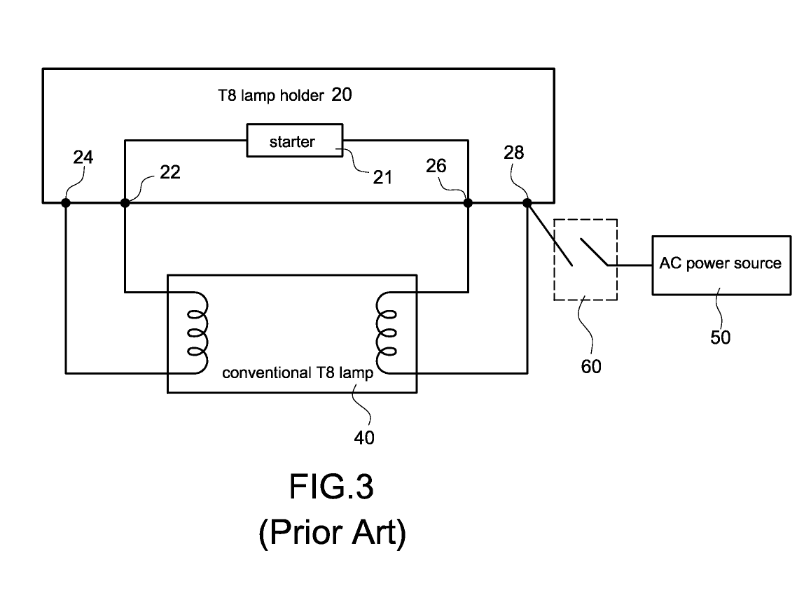

### DETAILED DESCRIPTION OF THE INVENTION

Reference will now be made to the drawing figures to describe the present invention in detail.

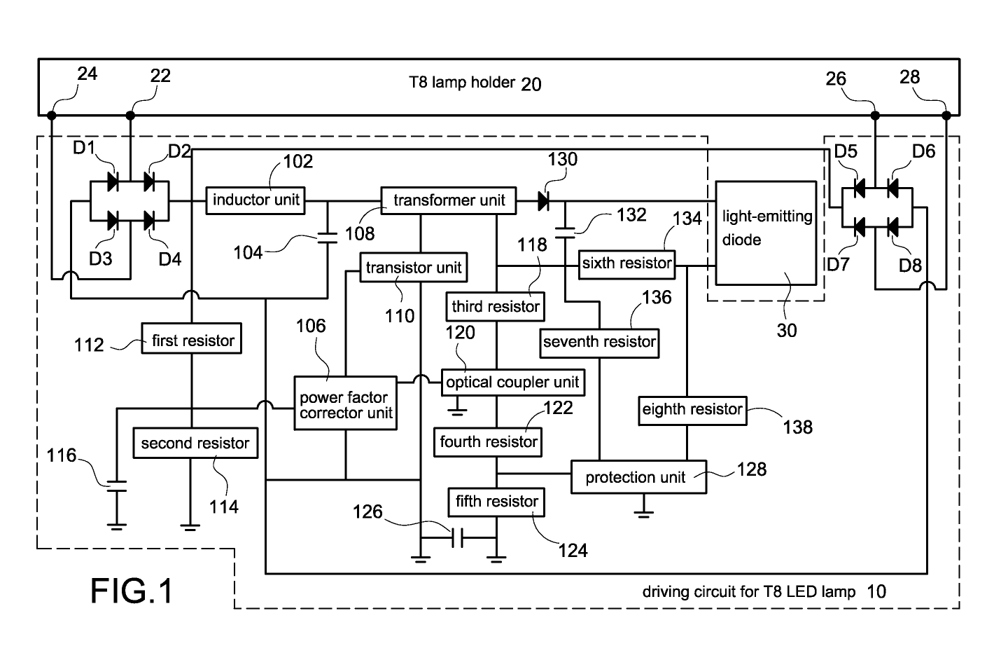

Reference is made to FIG. 1 which is s a block diagram of a driving circuit for a T8 LED lamp according to the present invention. The driving circuit of the T8 LED lamp 10 is applied to a T8 lamp holder 20 and at least one light-emitting diode 30. The T8 lamp holder 20 has a first lamp contact 22, a second lamp contact 24, a third lamp contact 26, and a fourth lamp contact 28.

The driving circuit of the T8 LED lamp 10 includes a first diode D1, a second diode D2, a third diode D3, a fourth diode D4, a fifth diode D5, a sixth diode D6, a seventh diode D7, an eighth diode D8, an inductor unit 102, a first capacitor 104, a power factor corrector unit 106, a transformer unit 108, a transistor unit 110, a first resistor 112, a second resistor 114, a second capacitor 116, a third resistor 118, an optical coupler unit 120, a fourth resistor 122, a fifth resistor 124, a third capacitor 126, a protection unit 128, a ninth diode 130, a fourth capacitor 132, a sixth resistor 134, a seventh resistor 136, and an eighth resistor 138.

Each of the first diode D1, the second diode D2, the third diode D3, the fourth diode D4, the fifth diode D5, the sixth diode D6, the seventh diode D7, the eighth diode D8, and the ninth diode 130 has an anode and a cathode, respectively. Each of the first resistor 112, the second resistor 114, the third resistor 118, the fourth resistor 122, the fifth resistor 124, the sixth resistor 134, the seventh resistor 136, the eighth resistor 138, the inductor unit 102, the first capacitor 104, the second capacitor 116, the third capacitor 126, the fourth capacitor 132, the optical coupler unit 120, and the light-emitting diode 30 has a first terminal and a second terminal, respectively. The first lamp contact 22 is electrically connected to the cathode of the first diode D1 and the anode of the second diode D2. The second lamp contact 24 is electrically connected to the cathode of the third diode D3 and the anode of the fourth diode D4. The third lamp contact 26 is electrically connected to the anode of the fifth diode D5 and the cathode of the sixth diode D6. The fourth lamp contact 28 is electrically connected to the anode of the seventh diode D7 and the cathode of the eighth diode D8.

The cathode of the second diode D2 is electrically connected to the cathode of the fourth diode D4, the cathode of the fifth diode D5, the cathode of the seventh diode D7, the first terminal of the first resistor 112, and the first terminal of the inductor unit 102, respectively. The second terminal of the first resistor 112 is electrically connected to the first terminal of the second capacitor 116, the first terminal of the second resistor 114, and the power factor corrector unit 106. The second terminal of the second capacitor 116 and the second terminal of the second resistor 114 are grounded.

The transformer unit 108 has four terminals, namely, a first terminal, a second terminal, a third terminal, and a fourth terminal. The transistor unit 110 has four terminals, namely, a first terminal, a second terminal, a third terminal, and a fourth terminal. The first terminal of the transformer unit 108 is electrically connected to the second terminal of the inductor unit 102 and the first terminal of the first capacitor 104. The second terminal of the transformer unit 108 is electrically connected to the first terminal of the transistor unit 110. The fourth terminal of the transformer unit 108 is electrically connected to the anode of the ninth diode 130. The cathode of the ninth diode 130 is electrically connected to the first terminal of the fourth capacitor 132 and the first terminal of the light-emitting diode 30.

The third terminal of the transformer unit 108 is electrically connected to the first terminal of the third resistor 118, the second terminal of the fourth capacitor 132, the first terminal of the sixth resistor 134, and the first terminal of the seventh resistor 136, respectively. The second terminal of the light-emitting diode 130 is electrically connected to the second terminal of the sixth resistor 134 and the first terminal of the eighth resistor 138. The second terminal of the seventh resistor 136 is electrically connected to the protection unit 128. The second terminal of the eighth resistor 138 is electrically connected to the protection unit 128.

The second terminal of the transistor unit 110 is electrically connected to the power factor corrector unit 106. The first terminal of the optical coupler unit 120 is electrically connected to the second terminal of the third resistor 118. The second terminal of the optical coupler unit 120 is electrically connected to the power factor corrector unit 106. The third terminal of the optical coupler unit 120 is grounded. The fourth terminal of the optical coupler unit 120 is electrically connected to the first terminal of the fourth resistor 122. The second terminal of the fourth resistor 122 is electrically connected to the protection unit 128 and the first terminal of the fifth resistor 124.

The anode of the first diode D1 is electrically connected to the anode of the third diode D3, the anode of the sixth diode D6, the anode of the eighth diode D8, the second terminal of the first capacitor 104, the power factor corrector unit 106, the third terminal of the transistor unit 110, and the first terminal of the third capacitor 126, respectively. The second terminal of the third capacitor 126 is electrically connected to the second terminal of the fifth resistor 124.

The first diode D1, the second diode D2, the third diode D3, and the fourth diode D4 form a bridge rectifier. The fifth diode D5, the sixth diode D6, the seventh diode D7, and the eighth diode D8 form a bridge rectifier.

The inductor unit 102 and the first capacitor 104 are provided to prevent the electromagnetic interference (EMI) from interfering with signal transmission. In the applied circuit design, the rectifying functions, which are provided though the first diode D1, the second diode D2, the third diode D3, the fourth diode D4, the fifth diode D5, the sixth diode D6, the seventh diode D7, and the eighth diode D8, are designed ahead of the inductor unit 102 and the first capacitor 104.

The sampling function, which is provided through the power factor corrector unit 106, is designed ahead of the inductor unit 102 and the first capacitor 104.

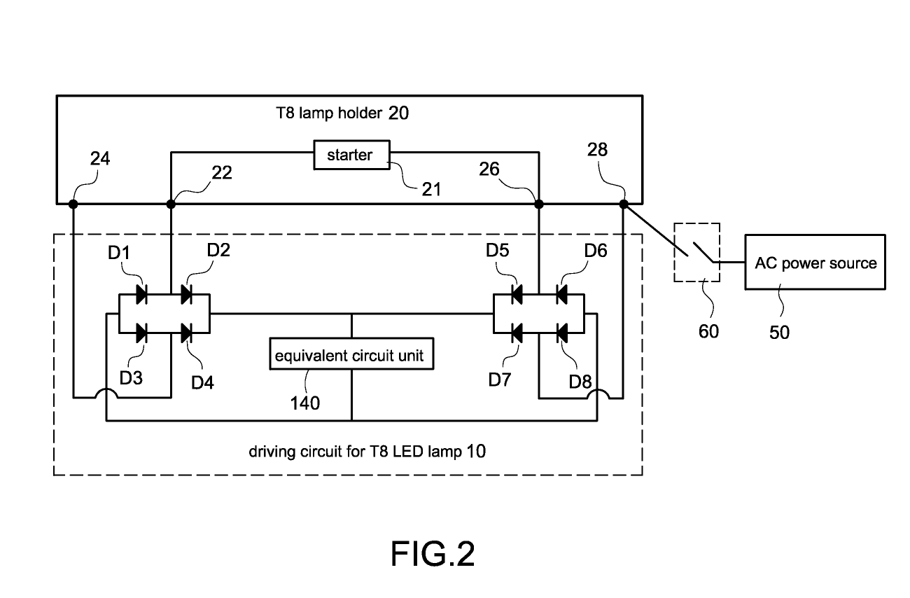

Reference is made to FIG. 2 which is a block diagram of an equivalent circuit of the driving circuit for the T8 LED lamp to demonstrate the principle of the driving circuit with ease. The remaining components are represented though an equivalent circuit 140 except the first diode D1, the second diode D2, the third diode D3, the fourth diode D4, the fifth diode D5, the sixth diode D6, the seventh diode D7, and the eighth diode D8.

As the above-mentioned description in the prior art, a starter 21 is installed between the first lamp contact 22 and the third lamp contact 26 to drive a conventional T8 lamp. An AC power source is electrically connected to the fourth lamp contact 28 through a switch 60. When the switch 60 is closed (turned on), different operations will be described as follows:
1. During the positive half-cycle of the AC power source 50, the seventh diode D7, the equivalent circuit unit 140, and the third diode D3 provide a half-wave rectifying function between the fourth lamp contact 28 and the second lamp contact 24. The first lamp contact 22 has a contact potential but the third lamp contact 26 does not because the fifth diode D5 is not conducted. Hence, the starter 21 is not activated.
2. During the negative half-cycle of the AC power source 50, the fourth diode D4, the equivalent circuit unit 140, and the eighth diode D8 provide a half-wave rectifying function between the second lamp contact 24 and the fourth lamp contact 28. The third lamp contact 26 has a contact potential but the first lamp contact 22 does not because the second diode D2 is not conducted. Hence, the starter 21 is not activated.

Accordingly, the light-emitting diode 30 can be driven to illuminate by the driving circuit for the T8 LED lamp 10. In fact, the existing lamp contacts of the T8 lamp holder 20 have various combinations in the market. According to the above-mentioned principle of the present invention, the light-emitting diode 30 can be driven by the driving circuit for T8 LED lamp while the starter 21 needs not be removed from the T8 lamp holder 20.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A driving circuit for a T8 light-emitting diode (LED) lamp applied to a T8 lamp holder and at least one light-emitting diode, the T8 lamp holder having a first lamp contact, a second lamp contact, a third lamp contact, and a fourth lamp contact; the driving circuit of the T8 LED lamp comprising:
a first diode having an anode and a cathode, and the cathode of the first diode electrically connected to the first lamp contact;
a second diode having an anode and a cathode, and the anode of the second diode electrically connected to the first lamp contact;
a third diode having an anode and a cathode, and the cathode of the third diode electrically connected to the second lamp contact and the anode of the third diode electrically connected to the anode of the first diode;
a fourth diode having an anode and a cathode, and the anode of the fourth diode electrically connected to the second lamp contact and the cathode of the fourth diode electrically connected to the cathode of the second diode;
a fifth diode having an anode and a cathode, and the anode of the fifth diode electrically connected to the third lamp contact and the cathode of the fifth diode electrically connected to the cathode of the second diode;
a sixth diode having an anode and a cathode, and the cathode of the sixth diode electrically connected to the third lamp contact and the anode of the sixth diode electrically connected to the anode of the first diode;
a seventh diode having an anode and a cathode, and the anode of the seventh diode electrically connected to the fourth lamp contact and the cathode of the seventh diode electrically connected to the cathode of the second diode;
an eighth diode having an anode and a cathode, and the cathode of the eighth diode electrically connected to the fourth lamp contact and the anode of the eighth diode electrically connected to the anode of the first diode;
an inductor unit having a first terminal and a second terminal, and the first terminal of the inductor unit electrically connected to the cathode of the second diode;
a first capacitor having a first terminal and a second terminal, and the first terminal of the first capacitor electrically connected to the second terminal of the inductor unit and the second terminal of the first capacitor electrically connected to the anode of the first diode; and
a power factor corrector unit electrically connected to the cathode of the second diode.

2. The driving circuit in claim 1, further comprising a transformer unit, wherein a first terminal of the transformer unit is electrically connected to one terminal of the first capacitor.

3. The driving circuit in claim 2, further comprising a transistor unit, wherein a first terminal of the transistor unit is electrically connected to a second terminal of the transformer unit and a second terminal of the transistor unit is electrically connected to the power factor corrector unit.

4. The driving circuit in claim 3, further comprising:
a first resistor, a first terminal of the first resistor electrically connected to the cathode of the second diode and a second terminal of the first resistor electrically connected to the power factor corrector unit;
a second resistor, a first terminal of the second resistor electrically connected to the second terminal of the first resistor and a second terminal of the second resistor grounded; and
a second capacitor, a first terminal of the second capacitor electrically connected to the second terminal of the first resistor and a second terminal of the second capacitor grounded.

5. The driving circuit in claim 4, further comprising:
a third resistor, a first terminal of the third resistor electrically connected to a third terminal of the transformer unit; and
an optical coupler unit, a first terminal of the optical coupler unit electrically connected to a second terminal of the third resistor and a second terminal of the optical coupler unit electrically connected to the power factor corrector unit, and a third terminal of the optical coupler unit grounded.

6. The driving circuit in claim 5, further comprising:
a fourth resistor, a first terminal of the fourth resistor electrically connected to a fourth terminal of the optical coupler unit;
a fifth resistor, a first terminal of the fifth resistor electrically connected to a second terminal of the fourth resistor; and
a third capacitor, a first terminal of the third capacitor electrically connected to a third terminal of the transistor unit and a second terminal of the third capacitor electrically connected to a second terminal of the fifth resistor.

7. The driving circuit in claim 6, further comprising a protection unit electrically connected to the first terminal of the fifth resistor.

8. The driving circuit in claim 7, further comprising a ninth diode having an anode and a cathode, the anode of the ninth diode electrically connected to a fourth terminal of the transformer unit and the cathode of the ninth diode electrically connected to a first terminal of the light-emitting diode.

9. The driving circuit in claim 8, further comprising:
a fourth capacitor, a first terminal of the fourth capacitor electrically connected to the cathode of the ninth diode and a second terminal of the fourth capacitor electrically connected to the third terminal of the transformer unit; and
a sixth resistor, a first terminal of the sixth resistor electrically connected to the third terminal of the transformer unit and a second terminal of the sixth resistor electrically connected to a second terminal of the light-emitting diode.

10. The driving circuit in claim 9, further comprising:
a seventh resistor, a first terminal of the seventh resistor electrically connected to the third terminal of the transformer unit and a second terminal of the seventh resistor electrically connected to the protection unit; and
an eighth resistor, a first terminal of the eighth resistor electrically connected to the second terminal of the light-emitting diode and a second terminal of the eighth resistor electrically connected to the protection unit.
